(19) United States
(12) Patent Application Publication
(10) Pub. No.: US 2022/0340489 A1
(43) Pub. Date: Oct. 27, 2022

(54) EXPANDED GRANULAR MATERIAL CONSISTING OF MINERAL MATERIAL

(71) Applicant: BINDER + CO AG, Gleisdorf (AT)

(72) Inventors: Hartmut KREMER, Wernberg (AT); Julian NEUBACHER, Graz (AT)

(73) Assignee: BINDER + CO AG, Gleisdorf (AT)

(21) Appl. No.: 17/762,453

(22) PCT Filed: Sep. 23, 2020
(86) PCT No.: PCT/EP2020/076555

§ 371 Date: Mar. 22, 2022

(30) Foreign Application Priority Data
Sep. 23, 2019 (EP) 19199056.3

(51) Int. Cl. C04B 14/18; C04B 26/26

(52) U.S. Cl. CPC C04B 14/185; C04B 26/26

(57) ABSTRACT

The invention relates to a method for producing an expanded granular material from sand grain-like mineral material which comprises a bound blowing agent, for example for producing an expanded granular material from perlite sand, wherein the sand grain-like mineral material is introduced into a feed opening at one end of a furnace shaft, conveyed along a thermal treatment section in a conveying direction, preferably by force of gravity, heated to a critical temperature while being conveyed through the thermal treatment section, starting at which temperature the sand grain-like mineral material plasticizes and begins to expand as a result of the blowing agent, and the expanded granular material is discharged at another end of the furnace shaft. In order to render the expanded granular widely usable, it is provided according to the invention that the sand grain-like mineral material is heated to a second temperature above the critical temperature after being heated to the critical temperature, which second temperature lies below a third temperature, starting at which third temperature the surface of the expanded granular material bursts, and wherein the second temperature is chosen depending on a desired density of the expanded granular material, so that a portion of the blowing agent remains in the granular material in bound form.

### FIELD OF THE INVENTION

The invention relates to a method for producing an expanded granular material from sand grain-like mineral material which comprises a bound blowing agent, for example for producing an expanded granular material from perlite sand, wherein the sand grain-like mineral material is introduced into a feed opening at one end of a furnace shaft, conveyed along a thermal treatment section in a conveying direction, preferably by force of gravity, heated to a critical temperature while being conveyed through the thermal treatment section, starting at which temperature the sand grain-like mineral material plasticizes and begins to expand as a result of the blowing agent, and the expanded granular material is discharged at another end of the furnace shaft.

The invention furthermore relates to an expanded granular material consisting of sand grain-like mineral material, for example an expanded granular material consisting of perlite sand, and to the use of the expanded granular material as mineral bulking agent in a bitumen product.

### PRIOR ART

In the construction industry, lightweight materials are sought-after starting materials for diverse applications such as insulating technology and the ready-mix plaster industry. The lightweight materials are basically divided into petroleum-based and mineral materials.

Petroleum-based materials are characterized by a well-researched production process, but have the disadvantage of combustibility.

By contrast, mineral materials, which are mainly (crystal) water-containing stone, such as perlite, obsidian and similar materials for example, in granular form, are not flammable. However, the production process is considerably less well-researched than that of petroleum-based materials.

Specifically in regard to the qualities attainable, the production process appears to still have a great deal of development potential.

From the prior art, furnaces have long been known in which hot combustion air is blown upwards from below through a vertically arranged tube. The sand grain-like mineral material that is to be expanded is thereby heated well above a critical temperature, which is normally situated between 750° C. and 800° C., in rare cases also above 800° C., in the counter current in the hot exhaust gas, starting at which temperature the sand grain-like mineral material plasticizes and the water bound in the sand grain-like mineral material evaporates. The expansion of the sand grain-like mineral material accompanies the evaporation process.

A major disadvantage of these furnaces is that the expansion process of the sand grain-like mineral material proceeds in a mainly uncontrolled manner—meaning that the sand grain-like mineral material is heated very rapidly and well above the critical temperature, so that the surface of the expanded granular material bursts. An open-celled, very light, fragile, but also highly hygroscopic granular material is formed as a result. Wherever this open-celled expanded granular material is mixed with other components to form a composite material, there occurs abrasion which reduces the volume, and in particular the cavity volume, of the open-celled expanded granular material, and therefore the desired lightening and insulating effect. Specifically in insulating technology and in the ready-mix plaster industry, the highly hygroscopic effect of the expanded granular material proves to be especially negative, since the granular material attracts and holds moisture. To counter the hygroscopy, a downstream impregnation with silicone is necessary. However, this entails a costly additional process step combined with the disadvantage of the combustibility of silicone starting at approx. 200° C.

In order to prevent the aforementioned disadvantages, a method for expanding sand grain-like mineral material is proposed in EP 2697181 B1, with which method it can be ensured that the expanded granular material possesses a mainly closed-celled surface, so that the granular material exhibits little or no hygroscopy.

The method described therein utilizes the finding that the expansion process is an isenthalpic process. The cooling of the granular material accompanying the isenthalpic expansion process is detected, and the temperature is reduced in a targeted manner along a residual fall distance of the expanded granular material, so that no further expansion process takes place.

Even though the granular material expanded using this method exhibits high quality and non-hygroscopic properties, certain application areas are nevertheless impossible due to unsuitable physical properties.

### OBJECT OF THE INVENTION

The object of the present invention is therefore to provide an expanded granular material consisting of mineral material, which granular material overcomes the stated disadvantages of the prior art. In particular, the expanded granular material shall be widely usable.

### DESCRIPTION OF THE INVENTION

This object is attained according to the invention with a method for producing an expanded granular material from sand grain-like mineral material which comprises a bound blowing agent, for example for producing an expanded granular material from perlite sand, wherein the sand grain-like mineral material
is introduced into a feed opening at one end of a furnace shaft,
conveyed along a thermal treatment section in a conveying direction, preferably by force of gravity,
heated to a critical temperature while being conveyed through the thermal treatment section, starting at which temperature the sand grain-like mineral material plasticizes and begins to expand as a result of the blowing agent,
and the expanded granular material is discharged at another end of the furnace shaft,
   in that the sand grain-like mineral material is heated to a second temperature above the critical temperature after being heated to the critical temperature, which second temperature lies below a third temperature, starting at which third temperature the surface of the expanded granular material bursts, and wherein the second temperature is chosen depending on a desired density of the expanded granular material, so that a portion of the blowing agent remains in the granular material in bound form.

It has become apparent that, unlike what is known and assumed from the prior art, there exists above the critical temperature a temperature range within which the expansion of the sand grain-like mineral material can be controlled in defined limits through the choice of a second temperature to which the sand grain-like mineral material is heated, without the surface of the expanded granular material bursting.

When reference is made to the bursting of the surface in this context, it should be noted that, for the purposes of the invention, a surface of an expanded granular material is not considered to have burst, and is therefore considered to be closed-celled, if less than 15%, preferably less than 10%, particularly preferably less than 5%, of the surface of the expanded granular material has burst and the remaining surface is smooth.

Surfaces that have burst to such a minor extent still achieve minimal or fully absent hygroscopy as well as a pronounced mechanical stability of the expanded granular material.

As has also become apparent, the controlled expansion of the sand grain-like mineral material makes it possible to set the density [kg/m³], or an expansion factor, of the expanded granular material for application fields relevant in practice. In other words, through a corresponding choice of the second temperature, an expanded granular material can be produced with different densities and thus different strengths, all of which nevertheless have closed surfaces and are mechanically stable and therefore non-hygroscopic.

The term “expansion factor” is to be understood as the ratio of the volume of the sand grain-like mineral material prior to the expansion process to the volume of the granular material after the expansion process. The “closer” the second temperature lies to the critical temperature, the “less” the sand grain-like mineral material is expanded, that is, the smaller the expansion factor of the granular material. Here, a portion of the blowing agent is not used for the expansion process. This blowing agent remains in the granular material in bound form. If the second temperature is increased, the expansion factor of the granular material also increases. The “closer” the second temperature lies to the third temperature, the greater the amount of blowing agent used for the expansion process—that is, the lower the amount of blowing agent remaining in the granular material in bound form.

This means that, through the choice of the second temperature, the expansion process is controlled to the extent that the residual moisture of the expanded granular material, that is, the fraction of water in the starting material not used for the expansion, is thus set, whereby the density of the expanded granular material can in turn be set in a targeted manner. The lower the second temperature chosen, the higher the density of the expanded granular material. The higher the second temperature chosen, the lower the density of the expanded granular material. Since the density is proportional to the mechanical strength, the mechanical strength of the expanded granular material is also lower with a lower density of the expanded granular material, whereas the mechanical strength of the expanded granular material is higher with a higher density of the expanded granular material. Thus, for any practical application of the expanded granular material, the strength at which the mechanical strength is exactly sufficient can always be chosen. It is therefore ensured that the expanded granular material is precisely as stable as necessary, yet as light as possible at the same time. The expanded granular material is thus widely usable and, with the aid of the method according to the invention, can be adapted to the respective application case such that the solution is particularly efficient.

In a particularly preferred embodiment of the invention, the method proceeds as follows:

The sand grain-like mineral material is, while being conveyed through the thermal treatment section, first heated to the critical temperature and subsequently to the second temperature. Starting at the critical temperature, the sand grain-like mineral material, which contains numerous grains that each comprise a structure and a surface, plasticizes—that is, the sand grain-like mineral material becomes soft.

Because of the blowing agent, the majority of the sand grain-like mineral material begins to expand at the critical temperature. In this context, “majority” is understood as meaning that more than 80%, preferably more than 90%, particularly preferably more than 95%, of the sand grain-like mineral material fed begins to expand.

Since not all grains of the sand grain-like mineral material fed have the same physical and chemical parameters, it cannot be entirely avoided that, for a certain number of grains, the plasticization, and therefore the expansion process, does not begin until later than for the majority of the grains. For this reason, it is advantageous if the sand grain-like mineral material fed comprises grains with the most identical properties possible, so that the heating of the sand grain-like mineral material effects the same reaction for all grains, but at least for the majority of the grains, when the method according to the invention is carried out.

The second temperature lies in a range between the critical temperature and the third temperature, wherein the surface of the granular material bursts at the third temperature. In the range between the critical temperature and the third temperature, the sand grain-like mineral material expands to the furthest possible extent without bursting.

The structure and the surfaces of the sand grain-like mineral material possess a temperature-dependent viscosity. At higher temperature, the surfaces and the bodies of the sand grain-like mineral material are less viscous, which is why the sand grain-like mineral material is expanded more greatly by the evaporating blowing agent. Below the critical temperature, the viscosity is so high that the surfaces and the bodies of the sand grain-like mineral material do not plasticize and no expansion process takes place. Above the third temperature, however, the viscosity of the bodies and the surfaces is so low, and the evaporating pressure of the blowing agent on the other hand so high, that the surfaces of the expanded granular material burst over the course of the expansion process. This means that the viscosity of the granular material, the expansion process and, by extension, the density and the mechanical strength of the expanded granular material are set via the level of the second temperature.

As previously mentioned above, it has become evident that, through the level of the second temperature, the expansion factor or the density of the expanded granular material can be set in a targeted manner, namely such that the level of the second temperature is inversely proportional to the density of the expanded granular material; that is, the lower the second temperature chosen, the higher the density of the expanded granular material and vice versa. As previously stated above, the density is proportional to the mechanical strength. Therefore, the mechanical strength of the expanded granular material is also lower with a lower density of the expanded granular material, whereas the mechanical strength of the expanded granular material is higher with a higher density of the expanded granular material. Thus, for any practical application of the expanded granular material, the strength at which the mechanical strength is exactly sufficient can always be chosen.

In this manner, it is ensured that the expanded granular material not only possesses the advantages which accompany a closed-celled construction, but that it is in addition precisely as stable as necessary, yet as light as possible at the same time. The expanded granular material is thus widely usable and, with the aid of the method according to the invention, can be adapted to the respective application case such that the solution is particularly efficient.

The grains of the expanded granular material with a closed-celled surface are ideally spherically embodied, but can also have an egg shape, potato shape, or the shape of multiple entities connected to one another—similar to multiple soap bubbles connected to one another.

The blowing agent is bound, in a more or less uniform manner, within the volume of the grains of the granular material. Over the course of the expansion process, multiple expanded cells can form within a grain—depending on a distribution of the blowing agent—which cells do not separate from one another, whereby multiple entities connected to one another are formed.

In an alternative embodiment of the method according to the invention, it is provided that the sand grain-like mineral material is, upon being introduced into the furnace shaft, first preheated to a preheating temperature lying below the critical temperature, preferably preheated to maximally 750° C., in preparation for the expansion process.

Depending on the starting material in the form of sand grain-like mineral material, it is not necessary that 750° C. also actually be reached over the course of the preheating. It is merely essential that 750° C. not be exceeded, whereas depending on the grain size of the starting material, the value can also be well below 750° C. The preheating temperature can thus also lie in the range between 500° C. and 650° C., for example.

The preheating serves to gradually heat the sand grain-like mineral material through to an innermost region prior to the expansion process. Through the heating to the preheating temperature, all layers of the sand grain-like mineral material—starting from a surface and proceeding to a core—are heated gradually and not abruptly.

It is to be ensured that, through the preheating, a most consistent temperature profile possible develops within the layers of the sand grain-like mineral material. By limiting the preheating temperature, it is prevented that, in the case of excessively rapid heating to the critical temperature, external layers close to the surface already expand and form an insulating layer before the core has been heated. Furthermore, the limiting of the preheating temperature serves to prevent the blowing agent from developing such great pressure that the sand grain-like mineral material expands uncontrollably, whereby the surface bursts.

In an alternative embodiment of the method according to the invention, it is provided that an amount of time until the preheating temperature is reached is between 0.5 and 1.5 seconds, preferably between 0.5 and 2 seconds, particularly preferably between 0.5 and 3 seconds.

As previously stated above, it is considered essential that the starting material be preheated gradually in the furnace shaft, and that it not be heated abruptly. In addition to limiting the preheating temperature it is therefore also necessary to regulate the supply of heat in the furnace shaft such that the preheating temperature (not necessarily the maximum preheating temperature) is reached as gradually as possible under the process engineering boundary conditions (available conveying section).

The temperature increase until the preheating temperature is reached preferably occurs in a linear manner. However, it is also conceivable that the temperature increase until the preheating temperature is increased takes place in an exponential or limited manner.

In a preferred embodiment of the method according to the invention, it is provided that the thermal treatment section comprises heating elements for emitting heat onto the sand grain-like mineral material, wherein the activation of heating elements arranged within at least 1 m, preferably within at least 2.5 m, particularly preferably within at least 4 m, as measured from the feed opening, occurs at a feed temperature of maximally 750° C.

In this manner, the start of the expansion process in the furnace shaft can be moved downwards as far as possible, depending on the starting material and the density being set. The farther downwards the start of the expansion process is moved, the longer and more uniform the preheating. In any case, however, it must be ensured that the remaining conveying section is sufficient for reaching the second temperature, and therefore the desired density.

Thus, with a correspondingly light starting material, it can be sufficient to merely activate the heating elements arranged within 1 in after the feed opening at a feed temperature of maximally 750, since this can be sufficient for the gradual, even heating. With heavier starting material, on the other hand, it may be necessary to activate all heating elements arranged within 4 m after the feed opening at a feed temperature of maximally 750° C., since in this case the even, continuous heating requires a longer fall distance.

In an alternative embodiment of the method according to the invention, it is provided that the activation of the heating elements located after the heating elements activated using the feed temperature in the conveying direction occurs at a temperature that lies above the feed temperature, preferably between 800° C. and 1100° C. It is thus ensured that at least the critical temperature is reached so that an expansion process occurs.

In an alternative embodiment of the method according to the invention, it is provided that the second temperature lies in a range between the critical temperature and 1.5 times or 1.4 times or 1.3 times or 1.2 times or 1.1 times the critical temperature. This means that, depending on the nature of the raw material and the initial grain size, the second temperature will not exceed 1.5 times the critical temperature. Through the choice of the second temperature, which in any case lies below the third temperature, it is ensured that—depending on the starting material—more than 85%, preferably more than 90%, particularly preferably more than 95%, of the expanded granular material comprises a closed-celled, unbursted surface following the expansion process at the second temperature.

In an alternative embodiment of the method according to the invention, it is provided that the first temperature and/or the critical temperature and/or the third temperature is determined experimentally for a specific type of starting material prior to the introduction into the furnace shaft, wherein the first and/or the critical temperature are determined, for example, with the aid of a test furnace, preferably with the aid of a muffle furnace. This means that the determination of the corresponding temperatures occurs—particularly for unfamiliar starting materials—experimentally and chronologically before the granular material is introduced into the oven shaft. For this purpose, among other things the moisture content of the granular material and the mass decrease thereof during drying are ascertained. For similar starting materials (raw sand type and grain size), however, a new determination is not necessary.

The first temperature and/or the critical temperature and/or the third temperature are then ascertained depending on a material class of the sand grain-like mineral material, on an initial grain size of the sand grain-like mineral material, and on the mass of the blowing agent. The second temperature is then chosen depending on the desired density that is to be obtained.

In an alternative embodiment of the method according to the invention, it is provided that the blowing agent contains water, which water is bound in the sand grain-like mineral material.

As previously stated above, the sand grain-like mineral material plasticizes at the critical temperature, wherein the evaporating water-containing blowing agent applies pressure to the sand grain-like mineral material, in particular to the surface of the sand grain-like mineral material, whereby the blowing process occurs.

In an alternative embodiment of the method according to the invention, it is provided that, once the second temperature is reached, the supply of heat to the expanded granular material is regulated such that the temperature of the expanded granulate is not further increased. In this manner, a further expansion process is impeded, a tearing-open of the expanded granular material is prevented, and the expansion factor set by the second temperature can be maintained. A large part—that is, more than 85%, preferably more than 90%, particularly preferably more than 95%—of the expanded granular material thus has at the other end of the furnace shaft a closed-celled surface and a density set in a targeted manner by the second temperature. The expanded granular material is then characterized by an absent hygroscopy, or a hygroscopy that is only slightly negative for practical application, and high mechanical stability.

Preferably, the heat output of the heating elements is successively reduced in the heating zones in the remaining thermal treatment section after the expansion process. This means that, once the second temperature has been reached, the temperature of the expanded granular material decreases.

It would be conceivable that the second temperature is first reached in a region of the thermal treatment section, which region is close to the other end of the furnace shaft. This has the advantage that the number of heating elements located after this region, as viewed in the conveying direction, can be kept low.

If the expansion process takes place in a region of the thermal treatment section, which region is not close to the other end of the furnace shaft, but rather in a middle segment of the furnace shaft for example, it would also be conceivable that the output of the heating elements located after the region in which the second temperature is reached in the conveying direction is set to zero.

It is thus ensured that no further expansion process occurs after this region, and that the expanded granular material, which comprises an essentially closed-celled surface, does not burst.

According to the invention, the expanded granular material can be used as mineral bulking agent in a bitumen product. This is a particularly preferred area of application for the expanded granular material having a closed-celled surface and a density set in a targeted manner. Through the use of the expanded granular material, the weight of the bitumen product can actually be optimized without negatively influencing the sealing effect of the bitumen product.

### WAYS OF EMBODYING THE INVENTION

The invention will now be explained in greater detail with the aid of two exemplary embodiments, wherein perlite sand is used in both exemplary embodiments as raw material for the production of the expanded granular material.

In the first exemplary embodiment (perlite A), the unexpanded perlite sand A has an initial grain size in a range of 100 μm to 300 μm. Above a critical temperature, which in this exemplary embodiment lies at 790° C., and below a third temperature, which lies at >1080° C., there exists a temperature range within which the expansion of the perlite sand A can be controlled through the choice of a second temperature to which the perlite sand A is heated—without the surface bursting, in that a portion of the blowing agent remains in the granular material in bound form and is not used for expansion.

Through this controlled expansion and partial non-use of the bound blowing agent, a bulk density and, concomitantly, a compressive strength of the expanded perlite A can be set for application fields relevant in practice.

Table 1 shows—purely by way of example—an overview of the correlation between the second temperature and bulk density of the expanded granular material, as well as the compressive strength thereof, for perlite A during heating to the second temperature. Furthermore, the residual moisture remaining in the expanded perlite grains A, which appears as a result of the bound blowing agent remaining in the expanded granular material, for example water, can also be seen from Table 1.

TABLE 1
Overview—Perlite A

| Critical | Second | Third | Bulk | Residual | Compressive |
|---|---|---|---|---|---|
| temp. | temp. | temp. | density | moisture | \| strength |
| [° C.] | [° C.] | [° C.] | [kg/m³] | [m %] | [N/mm²] |
| 790 | 1080 | >1080 | 90 | 0.74 | 0.15 |
| 790 | 1025 | >1080 | 160 | 0.93 | 0.80 |
| 790 | 995 | >1080 | 250 | 1.10 | 1.30 |
| 790 | 950 | >1080 | 400 | 1.40 | 3.60 |

In the first exemplary embodiment, the perlite sand A is, while being conveyed through a thermal treatment section, first brought to the critical temperature of 790° C. and subsequently heated to the second temperature. The perlite sand A plasticizes starting at the critical temperature of 790° C., wherein the water bound in the perlite sand A, which is referred to as crystal water, begins to evaporate and thus acts as a blowing agent. Accompanying the start of the evaporation process is the expansion of the perlite sand A to a multiple of its original volume. When heated above the third temperature, which in this exemplary embodiment lies above 1080° C. and can thus be 1090° C. or 1100° C. or 1200° C. for example, the surface of the perlite A begins to burst. The water that was still bound in the granular material in the beginning evaporates completely.

However, if the temperature is limited to a temperature (second temperature) below the third temperature, the water remains in the granular material in bound form. Therefore, the fraction of the bound water remaining in the granular material, and thus the bulk density that is to be obtained, can be set through the selection of the second temperature.

This fact is evident from Table 1 on the basis of numerical values. Since there is proportionality between the bulk density and compressive strength, the compressive strength can also be set through the choice of the second temperature. In concrete terms, this means: The lower the second temperature chosen, the higher the bulk density of the expanded perlite A and therefore also the compressive strength thereof. The higher the second temperature chosen, the lower the bulk density of the expanded perlite A and therefore also the compressive strength thereof. Thus, through a corresponding choice of the second temperature, it can be ensured that the closed-celled, expanded, and therefore non-hygroscopic perlite A is precisely as stable as necessary, yet as light as possible at the same time—the expanded perlite A is thus widely usable.

For perlite A, the lowest bulk density of 90 kg/m³ and the lowest compressive strength of 0.15 N/mm² are obtained at a second temperature of approx. 1080° C.—for the reason that, in this case, the second temperature lies very close to the third temperature. A high bulk density of 400 kg/m³ and a high compressive strength of 3.60 N/mm² of the expanded perlite A are obtained at a second temperature of 950° C.—in this case the second temperature lies closer to the critical temperature. For comparison: The bulk density of the unexpanded perlite sand A (raw material) is approx. 1050 kg/m³; the moisture is 3.66 m %, which is intended to serve solely as a reference value for the original fraction of bound water.

Thus, the “closer” the second temperature lies to the critical temperature, the “less” the perlite sand A is expanded. Here, a portion of the water remains in the perlite A in bound form. The “closer” the second temperature lies to the third temperature, the more water that evaporates—that is, the less water that remains in the perlite A in bound form. The residual moisture shown in Table 1 is a measure of the water remaining in the perlite A after the expansion process. At a bulk density of the expanded perlite A of 90 kg/m³, only 0.74 m % of bound water remains in the expanded perlite A, whereas at a bulk density of 400 kg/m³, 1.40 m % of bound water remains in the expanded perlite A. In this context, it should be noted that the unit of residual moisture used here is mass fraction [m %].

In the second exemplary embodiment (perlite B), the unexpanded perlite sand B has an initial grain size in a range of 75 μm to 170 μm. The statements/definitions generally made in the first exemplary embodiment with regard to the critical temperature, second temperature, third temperature, bulk density, residual moisture, and compressive strength, and the relation thereof to one another, also apply to the second exemplary embodiment.

TABLE 2
Overview—Perlite B

| Critical | Second | Third | Bulk | Residual | Compressive |
|---|---|---|---|---|---|
| temp. | kemp. | temp. | density | moisture | strength |
| [° C.] | [° C.] | [° C.] | [kg/m³] | [m %] | [N/mm²] |
| 790 | 1015 | >1015 | 220 | 1.03 | 1.50 |
| 790 | 980 | >1015 | 300 | 1.25 | 2.20 |
| 790 | 950 | >1015 | 400 | 1.42 | 4.60 |
| 790 | 870 | >1015 | 450 | 1.53 | 5.00 |
| 790 | 825 | >1015 | 550 | 1.62 | 7.80 |

In the second exemplary embodiment, the perlite sand B is, while being conveyed through the thermal treatment section, likewise first brought to the critical temperature of 790° C. and subsequently heated to the second temperature. The perlite sand B also plasticizes starting at the critical temperature of 790° C. wherein the water bound in the perlite sand B begins to evaporate and thus acts as a blowing agent. When heated above the third temperature, which in this exemplary embodiment lies above 1015° C. and can thus be 1025° C. or 1050° C. or 1100° C. for example, the surface of the perlite B begins to burst. The water that was still bound in the granular material in the beginning evaporates completely.

For perlite B, the lowest bulk density of 220 kg/m³ and the lowest compressive strength of 1.50 N/mm² are obtained at a second temperature of approx. 1015° C. A high bulk density of 550 kg/m³ and a high compressive strength of 7.80 N/mm² of the expanded perlite B are obtained at a second temperature of 825° C. Regarding the residual moisture, it is noted that, in the second embodiment, 1.03 m % of bound water remains in the expanded perlite B at a bulk density of 220 kg/m³, whereas 1.62 m % of bound water remains in the expanded perlite B at a bulk density of 550 kg/m³. For comparison: The bulk density of the unexpanded perlite sand B (raw material) is approx. 1000 kg/m³; the moisture is 3.66 m %, which in this exemplary embodiment is also intended to serve solely as a reference value for the original fraction of bound water.

Among other things, it is evident from Table 2 that, due to the finer initial grain size compared to perlite A, the third temperature is lower for perlite B. As a result, for perlite sand B compared to perlite sand A, higher bulk densities of the expanded perlite B and therefore also higher compressive strengths are obtained.

For the person skilled in the art, it is understandable that it is particularly advantageous for the method according to the invention if the raw material being used is conditioned accordingly before it is subjected to the method according to the invention, in order to create the most identical starting conditions possible for the individual grains.

Particularly preferably, it is thereby provided that more than 80%, preferably more than 90%, particularly preferably more than 95%, of the raw material (for example, of the perlite sand A or the perlite sand B) begins to expand at the critical temperature stated in the two exemplary embodiments and begins to break open at the third temperature indicated in the tables, in order that it also be possible to ensure, through the choice of the second temperature, that only a portion of the water bound in the raw material is used for the expansion and the rest remains in the expanded granular material.

1. A method for producing an expanded granular material from sand grain-like mineral material which comprises a bound blowing agent, for example for producing an expanded granular material from perlite sand, wherein the sand grain-like mineral material
is introduced into a feed opening at one end of a furnace shaft,
conveyed along a thermal treatment section in a conveying direction, preferably by force of gravity,
heated to a critical temperature while being conveyed through the thermal treatment section, starting at which temperature the sand grain-like mineral material plasticizes and begins to expand as a result of the blowing agent, and
the expanded granular material is discharged at another end of the furnace shaft,
wherein the sand grain-like mineral material is heated to a second temperature above the critical temperature after being heated to the critical temperature, which second temperature lies below a third temperature, starting at which third temperature the surface of the expanded granular material bursts, and
wherein the second temperature is chosen depending on a desired density of the expanded granular material, so that a portion of the blowing agent remains in the granular material in bound form.

2. The method according to claim 1, wherein the sand grain-like mineral material is, upon being introduced into the furnace shaft, first preheated to a preheating temperature lying below the critical temperature, preferably preheated to maximally 750° C., in preparation for the expansion process.

3. The method according to claim 2, wherein an amount of time until the preheating temperature is reached is between 0.5 and 1.5 seconds, preferably between 0.5 and 2 seconds, particularly preferably between 0.5 and 3 seconds.

4. The method according to claim 1, wherein the thermal treatment section comprises heating elements for emitting heat onto the sand grain-like mineral material, and
wherein the activation of heating elements arranged within at least 1 m, preferably within at least 2.5 m, particularly preferably within at least 4 m, as measured from the feed opening, occurs at a feed temperature of maximally 750° C.

5. The method according to claim 4, wherein the activation of the heating elements located after the heating elements activated using the feed temperature in the conveying direction occurs at a temperature that lies above the feed temperature, preferably between 800° C. and 1100° C.

6. The method according to claim 1, wherein the second temperature lies in a range between the critical temperature and 1.5 times or 1.4 times or 1.3 times or 1.2 times or 1.1 times the critical temperature.

7. The method according to claim 1, wherein the first temperature and/or the critical temperature and/or the third temperature are determined experimentally prior to the introduction into the furnace shaft.

8. The method according to claim 1, wherein the blowing agent contains water, which water is bound in the sand grain-like mineral material.

9. The method according to claim 1, wherein, once the second temperature is reached, the supply of heat to the expanded granular material is regulated such that the temperature of the expanded granulate is not further increased.

10. An expanded granular material consisting of sand grain-like mineral material, for example an expanded granular material consisting of perlite sand, which expanded granular material is obtainable through a method according to claim 1.

11. A use of the expanded granular material according to claim 10 as mineral bulking agent in a bitumen product.
